(19) United States
(12) Patent Application Publication
(10) Pub. No.: US 2024/0422275 A1
(43) Pub. Date: Dec. 19, 2024

(54) IMAGE FORMING APPARATUS AND METHOD FOR CONTROLLING OPTIONAL PAPER FEEDER IN IMAGE FORMING APPARATUS

(71) Applicant: SHARP KABUSHIKI KAISHA, Sakai City (JP)

(72) Inventor: MASAKI AMEMIYA, Sakai City (JP)

(21) Appl. No.: 18/746,513

(22) Filed: Jun. 18, 2024

(30) Foreign Application Priority Data
Jun. 19, 2023 (JP) 2023-100211

(51) Int. Cl. H04N 1/00

(52) U.S. Cl. CPC H04N 1/00652; H04N 1/00745; H04N 1/00793

(57) ABSTRACT

An image forming apparatus includes: an image forming apparatus main body; and an optional paper feeder optionally attachable to the image forming apparatus main body, the image forming apparatus main body has: an image former that executes image forming processing to form an image on a sheet-like image recording medium; and a resist roller that conveys the image recording medium, and the optional paper feeder has: a first accommodation device that accommodates a plurality of the image recording media; a first paper feed roller that feeds the image recording media one by one to a first conveyance path connected to a conveyance position; and an acceleration/deceleration roller that conveys the image recording medium to the conveyance position, the image forming apparatus further includes: a controller that controls a conveyance speed of the image recording medium by the acceleration/deceleration roller.

### CROSS-REFERENCE TO RELATED APPLICATION

The present application claims priority from Japanese Application JP2023-100211, the content to which is hereby incorporated by reference into this application.

### BACKGROUND OF THE INVENTION

### 1. Field of the Invention

The present disclosure relates to an image forming apparatus and a method for controlling an optional paper feeder in the image forming apparatus and, in particular, to an image forming apparatus including: an image forming apparatus main body; and an optional paper feeder optionally attachable to the image forming apparatus main body and a method for controlling the optional paper feeder in the image forming apparatus.

### 2. Description of the Related Art

In image forming apparatuses of an electrophotographic type, an ink jet type, and the like, image forming processing, that is, printing is performed continuously on plural sheets in some cases. In such a case, the plural sheets are sequentially conveyed in units of one sheet from a paper feed cassette, which is a paper feed source. However, at the time of paper feeding from the paper feed cassette, paper feed timing may become off, and a so-called paper feeding delay may occur, for example, due to slipping of a paper feed roller responsible for the paper feeding. However, there is a technique capable of maintaining CPM (or PPM) even when such a paper feeding delay occurs. The CPM (or PPM) is the number of conveyed sheets per unit time, in other words, the number of printed sheets per unit time.

According to this technique, based on a sheet interval from a paper feed start time point of a predetermined sheet to a paper feed start time point of a next sheet, which is conveyed following the predetermined sheet, and also based on a paper feed linear speed curve of the latest next sheet in a case where a paper feed start of the next sheet is the latest, an acceleration time point, at which a conveyance speed of the next sheet is increased, is calculated. Then, at the calculated acceleration time point, the conveyance speed of the currently-fed next sheet is switched from a first paper feed linear speed to a second paper feed linear speed, which is higher than the first paper feed linear speed. As a result, the constant CPM is maintained even when the paper feed delay occurs.

### SUMMARY OF THE INVENTION

By the way, the CPM is an index that represents performance of the image forming apparatus. As a value of this CPM value is increased, productivity of the image forming apparatus is increased. As a measure of increasing this CPM value, increasing a printing speed, that is, increasing a so-called process speed is available. However, this measure leads to a cost increase (price increase) of the image forming apparatus. As another measure, reducing an interval between the sequentially-conveyed sheets, in detail, a sheet interval between a rear edge of the preceding sheet and a leading edge of the sheet following the preceding sheet is available. However, this other measure becomes a cause of a frequent conveyance error since a length of the allowable paper feed delay (a length of time), that is, a paper feed delay margin is reduced. In addition, an attempt to reduce the frequency of this conveyance error, again, leads to the cost increase of the image forming apparatus. A user who is conscious of the productivity of the image forming apparatus tends to perform a large volume of printing and, for this purpose, tends to purchase an optional paper feeder that is one of optional devices.

In view of the above, an object of the present disclosure is to provide a novel image forming apparatus capable of improving CPM by allowing attachment of an optional paper feeder to an image forming apparatus main body and using the optional paper feeder as a paper feed source and to provide a method for controlling an optional paper feeder in an image forming apparatus.

In order to achieve this purpose, the present disclosure includes a first disclosure according to an image forming apparatus, a second disclosure according to a method for controlling an optional paper feeder in an image forming apparatus.

Of those, the first disclosure according to the image forming apparatus includes an image forming apparatus main body and an optional paper feeder optionally attachable to the image forming apparatus main body. The image forming apparatus main body has an image former and a resist roller (may also be referred to as a “paper stop roller”). The image former executes image forming processing to form an image on a sheet-like image recording medium. Then, the resist roller conveys the image recording medium to an image forming processing position by the image former, in detail, measures timing at which a leading edge of the image recording medium enters the image forming processing position. The optional paper feeder has a first accommodation device, a first paper feed roller, and an acceleration/deceleration roller. The first accommodation device accommodates a plurality of the image recording media. The first paper feed roller feeds the image recording media one by one from the first accommodation device to a first conveyance path connected to a conveyance position of the image recording medium by the resist roller. The acceleration/deceleration roller conveys the image recording medium fed to the first conveyance path to the conveyance position by the resist roller. The first disclosure further includes a controller. This controller is provided in the image forming apparatus main body or the optional paper feeder. Then, the controller controls a conveyance speed of the image recording medium by the acceleration/deceleration roller such that a leading edge of the image recording medium conveyed by the acceleration/deceleration roller reaches the conveyance position by the resist roller at a predetermined time point at which a predetermined time elapses from a feeding start time point of the image recording medium to the first conveyance path by the first paper feed roller.

The first disclosure may further include a first detector. This first detector is provided at a position between the conveyance position of the image recording medium by the acceleration/deceleration roller and the conveyance position by the resist roller in the first conveyance path and near the conveyance position by the acceleration/deceleration roller, and detects the leading edge of the image recording medium. In this case, the controller may control the conveyance speed by the acceleration/deceleration roller on the basis of a detection result by the first detector. The first detector is provided in the image forming apparatus main body or the optional paper feeder.

The first disclosure may further include a second detector. The second detector is provided between a feeding position of the image recording medium to the first conveyance path by the first paper feed roller and the conveyance position of the image recording medium by the acceleration/deceleration roller in the first conveyance path, and detects the leading edge of the image recording medium. In this case, the controller may control the conveyance speed by the acceleration/deceleration roller on the basis of a detection result by the second detector. The second detector is provided in the optional paper feeder.

The first disclosure may further include a first detector and a second detector. As described above, the first detector is provided at the position between the conveyance position of the image recording medium by the acceleration/deceleration roller and the conveyance position by the resist roller in the first conveyance path and near the conveyance position by the acceleration/deceleration roller, and detects the leading edge of the image recording medium. The second detector is provided between the feeding position of the image recording medium to the first conveyance path by the first paper feed roller and the conveyance position of the image recording medium by the acceleration/deceleration roller in the first conveyance path, and detects the leading edge of the image recording medium. In this case, the controller may control the conveyance speed by the acceleration/deceleration roller on the basis of a detection result by each of the first detector and the second detector. Both of the first detector and the second detector are provided in the optional paper feeder.

The image forming apparatus main body may further have a second accommodation device and a second paper feed roller. Of these, the second accommodation device accommodates a plurality of the image recording media. The second paper feed roller feeds the image recording media one by one from the second accommodation device to a second conveyance path connected to the conveyance position by the resist roller. In this case, the image recording medium that is fed to the second conveyance path by the second paper feed roller is desirably conveyed, by the second paper feed roller, to the conveyance position by the resist roller. That is, it is desirable that a conveyance device other than the second paper feed roller and the resist roller is not provided between the conveyance position of the image recording medium by the second paper feed roller and the conveyance position by the resist roller in the second conveyance path.

Here, an image formation processing speed by the image former is the same in both of a case where the image forming processing is performed on the image recording medium conveyed from the first accommodation device to the conveyance position by the resist roller via the first conveyance path and a case where the image forming processing is performed on the image recording medium conveyed from the second accommodation device to the conveyance position by the resist roller via the second conveyance path.

In addition, a first sheet interval that is an interval of the image recording media at the conveyance position by the resist roller in a case where the plurality of the image recording media is continuously conveyed from the first accommodation device to the conveyance position by the resist roller via the first conveyance path is desirably smaller than a second sheet interval that is an interval of the image recording media at the conveyance position by the resist roller in a case where the plurality of the image recording media is continuously conveyed from the second accommodation device to the conveyance position by the resist roller via the second conveyance path. More strictly, the first sheet interval that is an interval between a rear edge of the preceding image recording medium and a leading edge of the following image recording medium following the preceding image recording medium at the conveyance position by the resist roller in the case where the plurality of the image recording media is continuously conveyed from the first accommodation device to the conveyance position by the resist roller via the first conveyance path. The second sheet interval is an interval between a rear edge of the preceding image recording medium and a leading edge of the following image recording medium following the preceding image recording medium at the conveyance position by the resist roller in the case where the plurality of the image recording media is continuously conveyed from the second accommodation device to the conveyance position by the resist roller via the second conveyance path.

The second disclosure according to a method for controlling an optional paper feeder in an image forming apparatus in the present disclosure includes a control step. Here, the image forming apparatus includes an image forming apparatus main body and an optional paper feeder optionally attachable to the image forming apparatus main body. The image forming apparatus main body has an image former and a resist roller. The image former executes image forming processing to form an image on a sheet-like image recording medium. Then, the resist roller conveys the image recording medium to an image forming processing position by the image former, in detail, measures timing at which a leading edge of the image recording medium enters the image forming processing position. The optional paper feeder has a first accommodation device, a first paper feed roller, and an acceleration/deceleration roller. The first accommodation device accommodates a plurality of the image recording media. The first paper feed roller feeds the image recording media one by one from the first accommodation device to a first conveyance path connected to a conveyance position of the image recording medium by the resist roller. The acceleration/deceleration roller conveys the image recording medium fed to the first conveyance path to the conveyance position by the resist roller. In the control step, a conveyance speed of the image recording medium by the acceleration/deceleration roller is controller such that a leading edge of the image recording medium conveyed by the acceleration/deceleration roller reaches the conveyance position by the resist roller at a predetermined time point at which a predetermined time elapses from a feeding start time point of the image recording medium to the first conveyance path by the first paper feed roller.

According to the present disclosure, it is possible to improve CPM by attaching the optional paper feeder to the image forming apparatus main body and using the optional paper feeder as the paper feed source.

### BRIEF DESCRIPTION OF THE DRAWINGS

FIG. 1 is a view schematically illustrating an internal configuration of an image forming apparatus according to a first embodiment of the present disclosure.

FIG. 2 is a view schematically illustrating a portion that includes: a paper conveyance path from a paper feed roller to a resist roller in an image forming apparatus main body in FIG. 1 and a paper conveyance path from a paper feed roller in an optional paper feeder to the resist roller in an enlarged manner.

FIG. 3 is a block diagram illustrating an electrical configuration of the image forming apparatus according to the first embodiment.

FIG. 4 is a diagram illustrating a relationship between a conveyance time and a conveyance distance of a sheet in the case where a main body cassette in the first embodiment is a paper feed source.

FIGS. 5A-5C include tables, each of which illustrates specifications including CPM in the case where the main body cassette in the first embodiment is the paper feed source.

FIG. 6 is a diagram illustrating the relationship between the conveyance time and the conveyance distance of the sheet in the case where the optional paper feeder in the first embodiment is the paper feed source.

FIG. 7 is a table illustrating the specifications including the CPM in the case where the optional paper feeder in the first embodiment is the paper feed source.

FIG. 8 is a flowchart illustrating a flow of a first control task in the first embodiment.

FIG. 9 is a flowchart illustrating a flow of a second control task in the first embodiment.

FIG. 10 is a diagram illustrating a relationship between a conveyance time and a conveyance distance of a sheet in the case where an optional paper feeder in a second embodiment of the present disclosure is a paper feed source.

FIG. 11 is a diagram illustrating a relationship between a conveyance time and a conveyance distance of a sheet in the case where an optional paper feeder in a third embodiment of the present disclosure is a paper feed source.

### DETAILED DESCRIPTION OF THE INVENTION

### First Embodiment

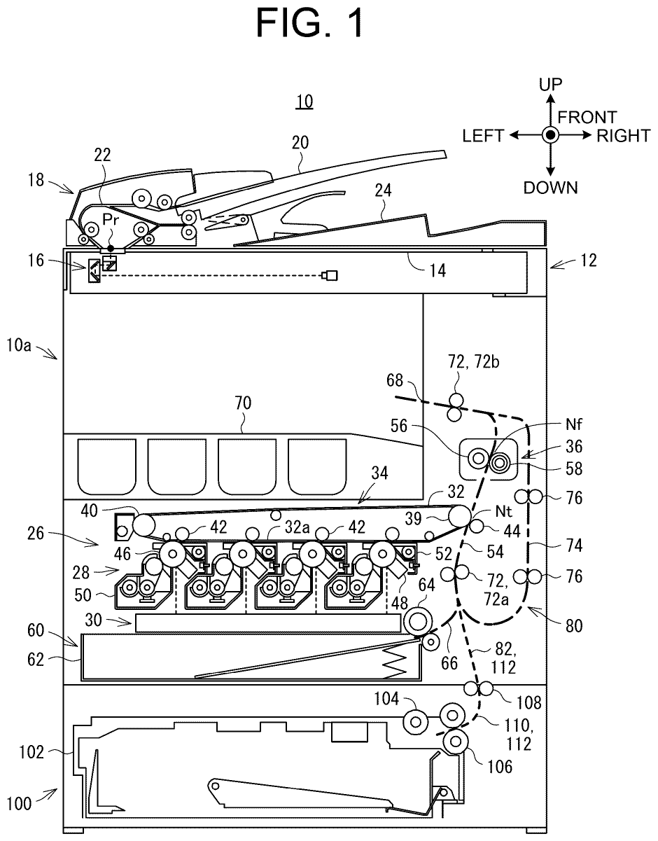

A description will be made on a first embodiment of the present disclosure by using an image forming apparatus 10 illustrated in FIG. 1 as an example.

The image forming apparatus 10 according to this first embodiment is a so-called multifunction peripheral (MFP) that has plural functions such as a copy function, a printer function, an image scanner function, and a facsimile function. FIG. 1 is a view of an internal configuration of the image forming apparatus 10, which is installed in a usable state and seen from a front side of the image forming apparatus 10. An up-down direction in FIG. 1 corresponds to an up-down direction of the image forming apparatus 10. A right-left direction in FIG. 1 corresponds to a right-left direction of the image forming apparatus 10. A near side of the sheet of FIG. 1 corresponds to the front side of the image forming apparatus 10. A back side of the sheet of FIG. 1 corresponds to a rear side of the image forming apparatus 10.

This image forming apparatus 10 includes an image forming apparatus main body 10a and an optional paper feeder 100 that is attached to a lower portion of this image forming apparatus main body 10a. The optional paper feeder 100 is one of optional devices and can be attached to the image forming apparatus main body 10a. That is, the image forming apparatus main body 10a functions as the MFP by itself. However, in the first embodiment, the image forming apparatus 10 is assumed that the optional paper feeder 100 is attached to the image forming apparatus main body 10a.

An image reader 12 as an image reading unit is provided in an upper portion of the image forming apparatus 10 (the image forming apparatus main body 10a). The image reader 12 performs image reading processing in which the image reader 12 reads an image of a document, which is not illustrated, and outputs two-dimensional read image data corresponding to the image of the document. For this purpose, the image reader 12 has a document table 14 on which the document is placed. The document table 14 is formed of a transparent member, such as glass, in a substantially rectangular flat plate shape, and is provided such that both main surfaces thereof are arranged horizontally. An image reading unit 16 is provided under the document table 14. Although not described in detail, the image reading unit 16 has a light source, a mirror, a lens, a line sensor, and the like. A linear image reading position Pr of the image reading unit 16 that extends in a front-rear direction of the image forming apparatus 10 is located on an upper surface of the document table 14. Under the document table 14, a drive mechanism (not illustrated) is provided to move (scan) the image reading position Pr of the image reading unit 16 in the right-left direction of the image forming apparatus 10. More specifically, when the drive mechanism moves the image reading position Pr of the image reading unit 16 in a state where the document is placed on the document table 14, the image of the document is read by a so-called fixed reading method. The front-rear direction of the image forming apparatus 10 is referred to as a primary scanning direction. The right-left direction of the image forming apparatus 10 is referred to as a secondary scanning direction.

An automatic document feeder (ADF) 18 is provided above the document table 14. The ADF 18 also serves as a document presser cover that presses the document placed on the document table 14. The ADF 18 is provided such that the ADF 18 can be shifted between a state of exposing an upper surface of the document table 14 to the outside and a state of covering the upper surface of the document table 14. For this reason, the ADF 18 is joined to the image forming apparatus main body 10a (casing) via an appropriate movable support member such as a hinge (not illustrated). FIG. 1 illustrates the state where the ADF 18 covers the upper surface of the document table 14. The ADF 18 exerts its original function in the state of covering the upper surface of the document table 14 as illustrated in FIG. 1.

The ADF 18 has a document placement tray 20. The document, more strictly, the sheet-like document can be placed on this document placement tray 20. In particular, plural sheets of the document can be stacked thereon. Although not described in detail, the ADF 18 takes in the document placed on the document placement tray 20 in units of one sheet (one by one) and conveys each sheet of the document on a document conveyance path 22 in the ADF 18. In the middle of conveyance, the document passes the image reading position Pr, more strictly, the fixed image reading position Pr. As a result, the image of the document is read by a so-called skimming method. Thereafter, the document is discharged to a document discharge tray 24.

An image former 26 as an image forming unit is provided under the image reader 12. This image former 26 performs image forming processing, that is, printing to form an image, which is based on appropriate image data such as the above-described read image data, on a sheet-like image recording medium (not illustrated) such as a sheet of paper. This printing is performed by a known electrophotographic method. In addition, the image former 26 employs a tandem system for color printing.

More specifically, the image former 26 has process units (also referred to as “image forming stations”) 28, 28, . . . as four single-color toner image forming units that separately form single-color toner images (not illustrated) in plural different colors, for example, four colors of yellow, magenta, cyan, and black. In addition, the image former 26 has an exposure device 30 as an exposure unit for lithographic exposure that is necessary for each of the process units 28, 28, . . . to form the single-color toner image. Furthermore, the image former 26 has a transfer unit 34 as a transfer device that sequentially transfers the single-color toner images formed by the process units 28, 28, . . . onto an intermediate transfer belt 32, which will be described below, and then transfers each of the transferred toner images on the intermediate transfer belt 32 onto the sheet. Moreover, the image former 26 has a fixing device 36 as a fixing unit. The fixing device 36 fixes the toner image, which has been transferred onto the sheet, onto the sheet.

The transfer unit 34 has: the intermediate transfer belt (also referred to as a “primary transfer belt”) 32; a drive roller 39 that rotates the intermediate transfer belt 32; and a driven roller 40. The intermediate transfer belt 32 is stretched between the drive roller 39 and the driven roller 40. Furthermore, the transfer unit 34 has: four intermediate transfer rollers (also referred to as “primary transfer rollers”) 42, 42, . . . , each of which is provided at a position corresponding to respective one of the process units 28, 28, . . . , on an inner side of the intermediate transfer belt 32; a transfer roller (also referred to as a “secondary transfer roller”) 44 as a transfer member; and the like.

The intermediate transfer belt 32 is stretched by the drive roller 39 and the driven roller 40. The drive roller 39 is rotated by receiving drive power from a motor (not illustrated) as an intermediate transfer belt drive unit, and is rotated counterclockwise in FIG. 1, for example. In association therewith, the intermediate transfer belt 32 is also rotated (rotationally moved) in the same direction, and the driven roller 40 is also rotated in the same direction. Of a region of the intermediate transfer belt 32 between the drive roller 39 and the driven roller 40, a lower region 32a is stretched horizontally. Then, each of the process units 28, 28, . . . is arranged in a manner to oppose this horizontally-stretched region 32a. The region 32a, where each of the process units 28, 28, . . . is arranged, in this intermediate transfer belt 32 is referred to as an intermediate transfer region. In this intermediate transfer region 32a, the intermediate transfer belt 32 moves from the left side to the right side of the image forming apparatus 10, that is, moves in the secondary scanning direction.

The intermediate transfer belt 32 is a flexible, endless belt-shaped body that is made of a synthetic resin (such as polyimide or polycarbonate) optionally mixed with a conductive material such as carbon black. Although not described in detail, the driven roller 40 also has a function to prevent loosening of the intermediate transfer belt 32 by applying an appropriate tensile force to the intermediate transfer belt 32.

Under the intermediate transfer region 32a of the intermediate transfer belt 32, the process units 28, 28, . . . are provided at regular intervals in a moving direction of the intermediate transfer belt 32 in the intermediate transfer region 32a, that is, in the secondary scanning direction. As described above, these process units 28, 28, . . . separately form the single-color toner images in the four colors of yellow, magenta, cyan, and black on the intermediate transfer belt 32. Although not illustrated in the drawings including FIG. 1, the process units 28, 28, . . . are provided in an order of those for yellow, magenta, cyan, and black from an upstream side to a downstream side (from the left side toward the right side in FIG. 1) in the moving direction of the intermediate transfer belt 32 in the intermediate transfer region 32a. However, this order is merely one example, and the arrangement order is not limited thereto. In addition, the process units 28, 28, . . . have the same structure except that the process units 28, 28, . . . form the single-color toner images in the mutually different colors on the intermediate transfer belt 32.

Each of the process units 28 includes a photosensitive drum 46, a charging device 48, a developing device 50, a cleaning device 52, a static eliminator (not illustrated), and the like.

The photosensitive drum 46 is an image carrier that carries an electrostatic latent image and a single-color toner image, which will be described below, and has a cylindrical base body that is formed of a conductive material such as aluminum. A photosensitive layer is formed on a surface (an outer circumferential surface) of this base body. In the intermediate transfer region 32a, the photosensitive drum 46 is provided such that the surface of the base body abuts an outer surface of the intermediate transfer belt 32, is rotated in this state by receiving drive power from a motor (not illustrated) as a drum drive unit, and is rotated clockwise in FIG. 1, for example. The photosensitive drum 46 is rotated at a speed corresponding to a moving speed of the intermediate transfer belt 32, more strictly, rotated at such a speed that a circumferential speed of the base body is slightly lower than the moving speed of the intermediate transfer belt 32 by about 0.1% to 0.3%, for example. This is to facilitate transfer of the single-color toner image, which is formed on a surface of the photosensitive drum 46 as will be described below, onto the outer surface of the intermediate transfer belt 32, in other words, to prevent a phenomenon in which the single-color toner image is not optionally transferred from the surface of the photosensitive drum 46 onto the outer surface of the intermediate transfer belt 32, especially, a hollow character phenomenon.

The charging device 48 is a charging unit that charges the surface of the photosensitive drum 46 to a predetermined potential. The surface of the photosensitive drum 46, which has been charged to the predetermined potential by this charging device 48, is exposed to light by the exposure device 30 described above. The exposure device 30 is provided under the arrangement of the process units 28, 28, . . . and exposes the surface of the photosensitive drum 46 in each of the process units 28 to light from below, that is, emits light in a mode, which corresponds to the image data to be printed, to the surface of the photosensitive drum 46. As a result, the electrostatic latent image in the mode, which corresponds to the image data to be printed, is formed on the surface of the photosensitive drum 46. Here, the exposure device 30 is a laser scanning unit (LSU) that has a laser diode (not illustrated) as a light source, a polygon mirror as a deflection unit, and the like, for example. However, instead of this, an LED unit may be employed as the exposure device 30. The LED unit has an LED array in which LEDs as the light sources are aligned.

The developing device 50 is a developing unit that develops the electrostatic latent image formed on the surface of the photosensitive drum 46. More specifically, the developing device 50 charges toner (not illustrated) by agitating the toner, makes this charged toner adhere to the electrostatic latent image on the photosensitive drum 46, and thereby visualizes, that is, develops the electrostatic latent image as the single-color toner image.

The single-color toner image, which is visualized through the development by this developing device 50, is transferred, that is, subjected to so-called intermediate transfer (primary transfer) from the surface of the photosensitive drum 46 to the outer surface of the intermediate transfer belt 32 at an abutment position between the surface of the photosensitive drum 46 and the outer surface of the intermediate transfer belt 32. For this purpose, the intermediate transfer roller 42 is provided in a manner to oppose the photosensitive drum 46 with the intermediate transfer belt 32 being interposed therebetween. The intermediate transfer roller 42 is provided such that a surface (an outer circumferential surface) thereof abuts the inner surface of the intermediate transfer belt 32. Then, the intermediate transfer roller 42 is rotated by receiving drive power that is generated by rotation of the intermediate transfer belt 32, that is, rotated counterclockwise in FIG. 1. When a predetermined intermediate transfer voltage is applied to the intermediate transfer roller 42 from an intermediate transfer power supply (not illustrated), a transfer electric field is formed between the surface of the photosensitive drum 46 and the outer surface of the intermediate transfer belt 32. Due to an effect of this transfer electric field, the single-color toner image on the photosensitive drum 46 is transferred onto the intermediate transfer belt 32.

In such a manner, the single-color toner images in the four colors of yellow, magenta, cyan, and black are separately formed on the intermediate transfer belt 32. Then, these single-color toner images in the four colors are superimposed on each other to form a color toner image on the intermediate transfer belt 32.

The cleaning device 52 is a cleaning unit that removes residual toner on the photosensitive drum 46 after the single-color toner image is transferred from the photosensitive drum 46 onto the intermediate transfer belt 32. The static eliminator (not illustrated) is a static elimination unit that eliminates static electricity on the photosensitive drum 46 after removal of the residual toner by the cleaning device 52. After the removal of the static electricity by this static elimination unit, the above-described step of charging by the charging device 48 onward are repeated.

The (color) toner image formed on the intermediate transfer belt 32 is transferred onto the sheet in a transfer nip section Nt. The transfer nip section Nt is an abutment portion between the intermediate transfer belt 32 and the transfer roller 44. More specifically, the transfer roller 44 is provided at a position where the transfer roller 44 opposes the drive roller 39 with the intermediate transfer belt 32 being interposed therebetween. The transfer roller 44 presses the intermediate transfer belt 32 with the drive roller 39. The transfer roller 44 is rotated by receiving the drive power that is generated by the rotation of the intermediate transfer belt 32, that is, rotated clockwise in FIG. 1. Then, a transfer bias current that has the same polarity as a charge polarity of the toner is applied from a transfer bias power supply (not illustrated) to the drive roller 39. Consequently, the transfer electric field is formed between the intermediate transfer belt 32 and the transfer roller 44, that is, in the transfer nip section Nt. When the sheet passes through the transfer nip section Nt in this state, the toner image on the intermediate transfer belt 32 is transferred onto the sheet. In short, the transfer nip section Nt is an image forming processing position for the sheet by the image former 26.

The fixing device 36 is provided on a downstream side of the transfer nip section Nt in a conveyance direction of the sheet that is conveyed along a paper conveyance path 54 described below. As described above, the fixing device 36 fixes the toner image on the sheet onto the sheet, in detail, fixes the toner image onto the sheet by heating and melting the toner image and further pressing the toner image. For this purpose, the fixing device 36 has a heating roller 56 and a pressure roller 58. These heating roller 56 and pressure roller 58 are provided in a state where surfaces (outer circumferential surfaces) thereof abut each other. The heating roller 56 is heated to a predetermined temperature (a fixing temperature) by an appropriate heat source, such as a lamp heater (not illustrated), provided therein. In addition, the heating roller 56 is rotated by receiving drive power from a motor as a fixing roller driving unit (not illustrated), and is rotated counterclockwise in FIG. 1, for example. In association therewith, the pressure roller 58 is also rotated, that is, rotationally driven clockwise in FIG. 1. Then, when the sheet, which has passed through the transfer nip section Nt, passes through a fixing nip section Nf as an abutment portion between the surface of the heating roller 56 and the surface of the pressure roller 58, the toner image on the sheet is fixed onto the sheet. With this, a series of the processing for printing by the image former 26 is terminated.

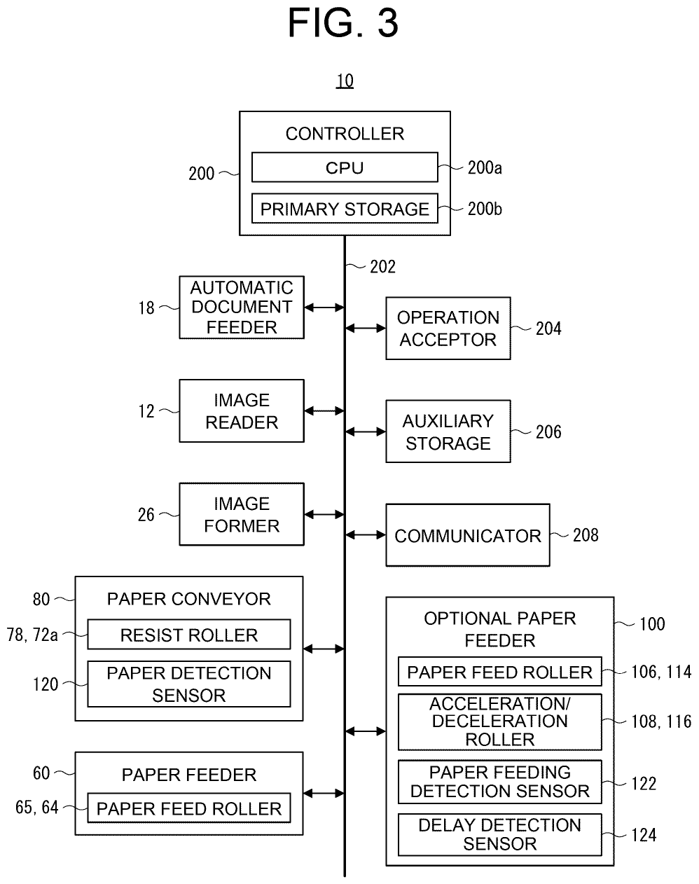

Furthermore, a paper feeder 60 as a paper feeding unit is provided under the image former 26, in other words, in the lower portion inside the image forming apparatus main body 10a. The paper feeder 60 has a main body cassette 62. Plural sheets can be stacked and accommodated in this main body cassette 62. In addition, the paper feeder 60 has a paper feed roller (more strictly, a roller pair) 64 that also serves as a pickup roller. The paper feed roller 64 picks up the sheets accommodated in the main body cassette 62 in units of one sheet (one by one), and feeds each of the sheets to the paper conveyance path 54 via a main body side conveyance path 66. The paper feed roller 64 is rotated by receiving drive power that is generated by a main body side paper feed motor 65 (see FIG. 3). Since the paper feed roller 64 also serves as the pickup roller, just as described, a configuration of the image forming apparatus main body 10a can be simplified, and this leads to a cost reduction (price reduction) of the image forming apparatus main body 10a.

The paper conveyance path 54 is provided to discharge the sheet, which has been supplied via the main body side conveyance path 66, from a paper discharge port 68 to a paper discharge tray 70 through the transfer nip section Nt and the fixing nip section Nf. Plural, for example, two conveyance rollers (more strictly, roller pairs) 72, 72 are each provided at an appropriate position in the paper conveyance path 54 to convey the sheet along the paper conveyance path 54. Of the conveyance rollers 72, 72, a conveyance roller 72a that is provided on an upstream side in a paper conveyance direction in the paper conveyance path 54, in other words, on an upstream side of the transfer nip section Nt is a resist roller that measures timing at which a leading edge of the sheet enters the transfer nip section Nt. For this purpose, the resist roller 72a temporarily stops the conveyance of the sheet and then restarts the conveyance of the sheet, that is, causes the leading edge of the sheet to enter the transfer nip section Nt. Meanwhile, a conveyance roller 72b that is provided on a downstream side in the paper conveyance direction in the paper conveyance path 54, in other words, provided near the paper discharge port 68 is a paper discharge roller that discharges the sheet from the paper discharge port 68 to the paper discharge tray 70. The paper discharge tray 70 is provided between the image reader 12 and the image former 26, that is, in a so-called internal body space. However, the position at which the paper discharge tray 70 is provided is not limited thereto.

In addition, a reverse conveyance path 74 for double-sided printing is provided in the image forming apparatus main body 10a. This reverse conveyance path 74 is a conveyance path that takes in the sheet, which has passed through the fixing nip section Nf, that is, the printed sheet once and subjects the sheet to printing again. That is, the sheet, which has been taken into the reverse conveyance path 74, is fed to the paper conveyance path 54 again through the reverse conveyance path 74, in detail, fed to an upstream side of the resist roller 72a. For this reason, conveyance rollers 76 are each provided at an appropriate position in the reverse conveyance path 74. Then, the sheet, which is fed to the upstream side of the resist roller 72a through the reverse conveyance path 74, is turned over, and printing is performed on this turned-over sheet to enable double-sided printing.

The resist roller 72a, the paper discharge roller 72b, and each of the conveyance rollers 76 provided in the reverse conveyance path 74 are each rotated by receiving drive power that is generated by a conveyance motor 78 (see FIG. 3) as a common conveyance drive source. These resist roller 72a, paper discharge roller 72b, conveyance rollers 76, and conveyance motor 78 cooperate with the paper conveyance path 54 to form a paper conveyor 80.

The optional paper feeder 100 is attached to the lower portion of the image forming apparatus main body 10a. The optional paper feeder 100 has an optional cassette 102. Plural sheets can be stacked and accommodated in this optional cassette 102. In addition, the optional paper feeder 100 has a pickup roller 104, a paper feed roller (more strictly, a roller pair) 106, and an acceleration/deceleration roller (more strictly, a roller pair) 108. The pickup roller 104 picks up the sheets, which are accommodated in the optional cassette 102, in units of one sheet (one by one). The paper feed roller 106 feeds the sheet, which has been picked up by the pickup roller 104, to an option-side conveyance path 110. The option-side conveyance path 110 is connected to the paper conveyance path 54 via an option connection conveyance path 82 in the image forming apparatus main body 10a. In other words, the option-side conveyance path 110 is connected to a nip section of the resist roller 72a, which is a paper conveyance position by the resist roller 72a, via the option connection conveyance path 82. Here, the option-side conveyance path 110 cooperates with the option connection conveyance path 82 to form an optional conveyance path 112.

The acceleration/deceleration roller 108 is provided near a portion of the option-side conveyance path 110 connected to the option connection conveyance path 82. The acceleration/deceleration roller 108 conveys the sheet, which has been fed to the option-side conveyance path 110 by the paper feed roller 106, to the nip section of the resist roller 72a via the option connection conveyance path 82, that is, via the optional conveyance path 112 including the option-side conveyance path 110 and the option connection conveyance path 82.

The paper feed roller 106 is rotated by receiving drive power that is generated by an option-side paper feed motor 114 (see FIG. 3). The pickup roller 104 is coupled to the paper feed roller 106 via a belt (not illustrated) as a drive power transmission unit, and is rotated (rotationally driven) in association with rotation of the paper feed roller 106. In addition, the pickup roller 104 is provided such that the pickup roller 104 can be displaced vertically by a vertical movement mechanism (not illustrated). Then, only when picking up the from the optional cassette 102, the pickup roller 104 is displaced downward and comes into contact with the (top) sheet in the optional cassette 102. Otherwise, the pickup roller 104 is located at a higher position, that is, in a separate state from the sheets in the optional cassette 102. The acceleration/deceleration roller 108 is rotated by receiving drive power that is generated by an acceleration/deceleration motor 116 (see FIG. 3) as an acceleration/deceleration drive source. That is, the paper feed roller 106 (and the pickup roller 104) and the acceleration/deceleration roller 108 are driven by the mutually different (that is, two) drive sources.

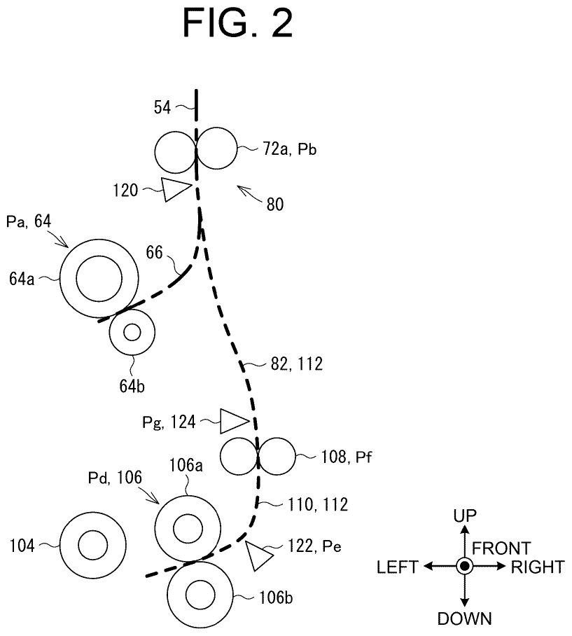

In addition, as illustrated in FIG. 2, a paper detection sensor 120 is provided at a position that is on an upstream side in the paper conveyance direction of the nip section of the resist roller 72a in the paper conveyance path 54 and that is near the nip section of the resist roller 72a. FIG. 2 is a schematic view illustrating a portion including a paper conveyance path from the paper feed roller 64 in the image forming apparatus main body 10a to the resist roller 72a and a paper conveyance path from the paper feed roller 106 in the optional paper feeder 100 to the resist roller 72a in an enlarged manner.

The paper detection sensor 120 is a paper detection unit that detects the leading edge of the sheet conveyed along the paper conveyance path 54. Based on a detection result by this paper detection sensor 120, a time point at which the leading edge of the sheet reaches the nip section of the resist roller 72a (that is, a temporary stop position of the sheet by the resist roller 72a) is estimated. This paper detection sensor 120 is a reflective photoelectric sensor, for example. However, the paper detection sensor 120 is not limited thereto. For example, the paper detection sensor 120 may be a transmissive photoelectric sensor or an appropriate sensor other than the photoelectric sensor.

A paper feeding detection sensor 122 is provided at a position that is located between a nip section of the paper feed roller 106 and a nip section of the acceleration/deceleration roller 108 and that is near the nip section of the paper feed roller 106. The nip section of the paper feed roller 106 corresponds to a paper feeding position to the optional conveyance path 112 by the paper feed roller 106 in the optional conveyance path 112. This paper feeding detection sensor 122 is a paper feeding detection unit that detects the leading edge of the sheet fed to the optional conveyance path 112 by the paper feed roller 106, that is, detects that the sheet is fed to the optional conveyance path 112 by the paper feed roller 106. Similar to the paper detection sensor 120, this paper feeding detection sensor 122 is also a reflective photoelectric sensor, for example. However, the paper feeding detection sensor 122 is not limited thereto. For example, the paper feeding detection sensor 122 may be a transmissive photoelectric sensor or an appropriate sensor other than the photoelectric sensor.

Furthermore, a delay detection sensor 124 is provided at a position that is located between the nip section of the acceleration/deceleration roller 108 in the optional conveyance path 112 and the nip section of the resist roller 72a and that is near the nip section of the acceleration/deceleration roller 108. This delay detection sensor 124 is a delay detection unit that detects the leading edge of the sheet conveyed by the acceleration/deceleration roller 108, that is, detects whether a paper feeding delay occurs. This delay detection sensor 124 is also a reflective photoelectric sensor, for example. However, the delay detection sensor 124 is not limited thereto. For example, the delay detection sensor 124 may be a transmissive photoelectric sensor or an appropriate sensor other than the photoelectric sensor.

The paper feed roller 64 in the image forming apparatus main body 10a has two rollers 64a, 64b. Of these, the one roller 64a is a drive roller that is rotated by receiving the drive power generated by the above-described main body side paper feed motor 65 (see FIG. 3), and the other roller 64b is a driven roller that is rotated in association with the rotation of the one roller 64a. In addition, the paper feed roller 64 also serves as the pickup roller as described above, and the one roller 64a has this function as the pickup roller. Meanwhile, the other roller 64b is a separation roller (may be also referred to as a “handling roller”) that separates the plural sheets and only feeds one sheet to the main body side conveyance path 66 at the time when the one roller 64a picks up the plural sheets from the main body cassette 62.

The paper feed roller 106 in the optional paper feeder 100 also has two rollers 106a, 106b. Of these, the one roller 106a is a drive roller that is rotated by receiving the drive power generated by the above-described option-side paper feed motor 114 (see FIG. 3), and the other roller 106b is a driven roller that is rotated in association with the rotation of the one roller 106a. Meanwhile, the other roller 106b is a separation roller that separates the plural sheets and only feeds one sheet to the optional conveyance path 112 at the time when the pickup roller 104 picks up the plural sheets from the optional cassette 102.

Hereinafter, the nip section of the paper feed roller 64 in the image forming apparatus main body 10a may be denoted by a reference sign “Pa”. The nip section of the resist roller 72a may be denoted by a reference sign “Pb”. The nip section of the paper feed roller 106 in the optional paper feeder 100 may be denoted by a reference sign “Pd”, and the detection position by the paper feeding detection sensor 122 may be denoted by a reference sign “Pe”. Furthermore, the nip section of the acceleration/deceleration roller 108 may be denoted by a reference sign “Pf”, and the detection position by the delay detection sensor 124 may be denoted by a reference sign “Pg”.

FIG. 3 is a block diagram illustrating an electrical configuration of the image forming apparatus 10. As illustrated in FIG. 3, the image forming apparatus 10 has a controller 200. The image reader 12, the ADF 18, the image former 26, the paper feeder 60, and the paper conveyor 80 are connected to the controller 200 via a bus 202. In addition, an operation acceptor 204, an auxiliary storage 206, a communicator 208, and the like are connected to the controller 200 via the bus 202. Furthermore, the optional paper feeder 100 is connected to the controller 200 via the bus 202. The image reader 12, the ADF 18, the image former 26, the paper feeder 60, the paper conveyor 80, and the optional paper feeder 100 are as described above.

In particular, the paper feeder 60 has the paper feed roller 64 and the main body side paper feed motor 65 as the drive source thereof. The paper conveyor 80 has the resist roller 72a and the conveyance motor 78 as the drive source thereof. The conveyance motor 78 also serves as the drive source of the conveyance rollers 76 that are provided in the paper discharge roller 72b and the reverse conveyance path 74. In addition, the paper conveyor 80 has the paper detection sensor 120. Furthermore, the optional paper feeder 100 has the paper feed roller 106 and the option-side paper feed motor 114 as the drive source thereof, and also has the acceleration/deceleration roller 108 and the acceleration/deceleration motor 116 as the drive source thereof. Moreover, the optional paper feeder 100 has the paper feeding detection sensor 122 and the delay detection sensor 124.

The controller 200 is an example of a control unit that controls the entire image forming apparatus 10. For this purpose, the controller 200 has a computer as a control executor, for example, a CPU 200a. In addition, the controller 200 has a primary storage 200b as a primary storage that is directly accessible by the CPU 200a. The primary storage 200b includes ROM and RAM, which are not illustrated, for example. The ROM stores a control program (firmware) for controlling operation of the CPU 200a. Meanwhile, the RAM constitutes a work area and a buffer area that are used when the CPU 200a executes processing based on the control program.

The operation acceptor 204 has a display with a touch panel (not illustrated). The display with the touch panel is a component in which the touch panel (not illustrated) as an example of an operation acceptor capable of accepting an operation by a user and a display as an example of a display unit displaying various types of information are integrally assembled. In addition to the display with the touch panel, the operation acceptor 204 an appropriate light emitting unit such as an LED (not illustrated) and an appropriate hardware switch such as a push button (not illustrated).

The auxiliary storage 206 is an example of an auxiliary storage unit. That is, the auxiliary storage 206 optionally stores various types of data such as the read image data described above. The auxiliary storage 206 has a hard disk drive (not illustrated), for example. The auxiliary storage 206 may have rewritable nonvolatile memory such as flash memory.

The communicator 208 is an example of a communication unit. More specifically, the communicator 208 performs bidirectional communication processing via a LAN line (not illustrated). The communicator 208 may be connected to the LAN line in a wired manner or a wireless manner. The communicator 208 also performs bidirectional communication processing via a public switched telephone network (not illustrated).

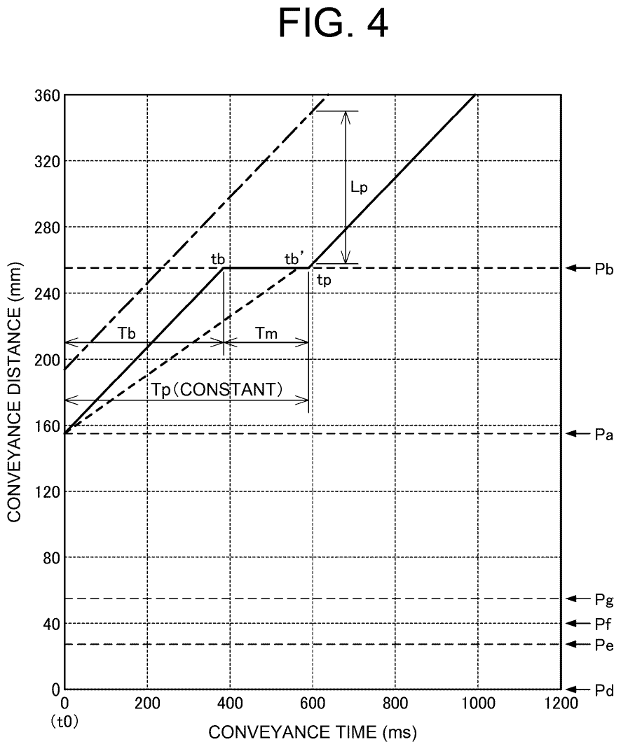

In the case where a supply source of the sheet to be printed by the image former 26, that is, the paper feed source is the main body cassette 62, the sheet is taken out from the main body cassette 62 by the paper feed roller 64 and is then conveyed to the paper conveyance path 54 via the main body side conveyance path 66. FIG. 4 is a diagram illustrating a relationship between a conveyance time and a conveyance distance of the sheet in this case.

In FIG. 4, a horizontal axis represents the conveyance time, and a vertical axis represents the conveyance distance. Then, a time point to at which the rotation of the paper feed roller 64 is started is set as a base point of the conveyance time. Meanwhile, a base point of the conveyance distance is set to the nip section Pd of the paper feed roller 106 in the optional paper feeder 100 in consideration of a case where the optional paper feeder 100 (the optional cassette 102) serves as the paper feed source, which will be described below. For this reason, in FIG. 4, the nip section Pa of the paper feed roller 64 is set at a position corresponding to the conveyance distance of about 155 mm. By the way, the nip section Pb of the resist roller 72a is located about 255 mm from the nip section Pd of the paper feed roller 106, which is the base point of the conveyance distance, in the optional paper feeder 100. In other words, a distance from the nip section Pa of the paper feed roller 64 to the nip section Pb of the resist roller 72a is about 100 mm (=about 255 mm-about 155 mm) and is relatively short. Thus, except for the paper feed roller 64 and the resist roller 72a, a conveyance unit is not provided between the nip section Pa of the paper feed roller 64 and the nip section Pb of the resist roller 72a. This also contributes to the simplification and the cost reduction of the configuration of the image forming apparatus main body 10a.

Furthermore, a bold solid line in FIG. 4 indicates transition of the leading edge of the sheet in a case where the sheet is conveyed ideally (as designed). A bold broken line in FIG. 4 indicates an example of the transition of the leading edge of the sheet in a case where the paper feed delay occurs. In addition, a bold one-dot chain line in FIG. 4 indicates transition of a rear edge of the preceding sheet in a case where printing is continuously performed on the plural sheets.

As indicated in this FIG. 4, in particular, as indicated by the bold solid line, when the sheet is conveyed ideally, the leading edge of the sheet reaches the nip section Pb of the resist roller 72a at a time point tb at which a predetermined time Tb elapses from the base point t. Meanwhile, when the paper feed delay occurs, as indicated by the bold broken line in FIG. 4, the leading edge of the sheet reaches the nip section Pb of the resist roller 72a at a time point tb′, which is later than the time point tb. In order to absorb this time lag (variation), an appropriate paper feed delay margin Tm is provided, and the resist roller 72a is not rotated, that is, the sheet is stopped until this paper feed delay margin Tm elapses. Then, at a time point tp at which the paper feed delay margin Tm elapses, the rotation of the resist roller 72a is started, and the sheet is conveyed to the transfer nip section Nt. At this time, the resist roller 72a conveys the sheet at a speed corresponding to (equivalent to) a process speed Vp that is a print speed (image formation processing speed) of the image former 26. Here, a time Tp from the base point t0 to the time point tp of the conveyance time is constant. In the case where the leading edge of the sheet does not reach the nip section Pb of the resist roller 72a before this time Tp elapses, that is, by the time point tp, a conveyance error occurs.

Here, as the paper feed delay margin Tm is increased (becomes longer), the conveyance error is less likely to occur, and so to speak, safety (adaptability) with respect to the paper feed delay is improved. On the contrary, in the case where printing is continuously performed on the plural sheets of paper, it is necessary to significantly increase a conveyance interval of each sheet, in detail, a processed sheet interval Lp that is an interval between the rear edge of the preceding sheet and the leading edge of the sheet following this preceding sheet in the nip section Pb of the resist roller 72a. This reduces CPM.

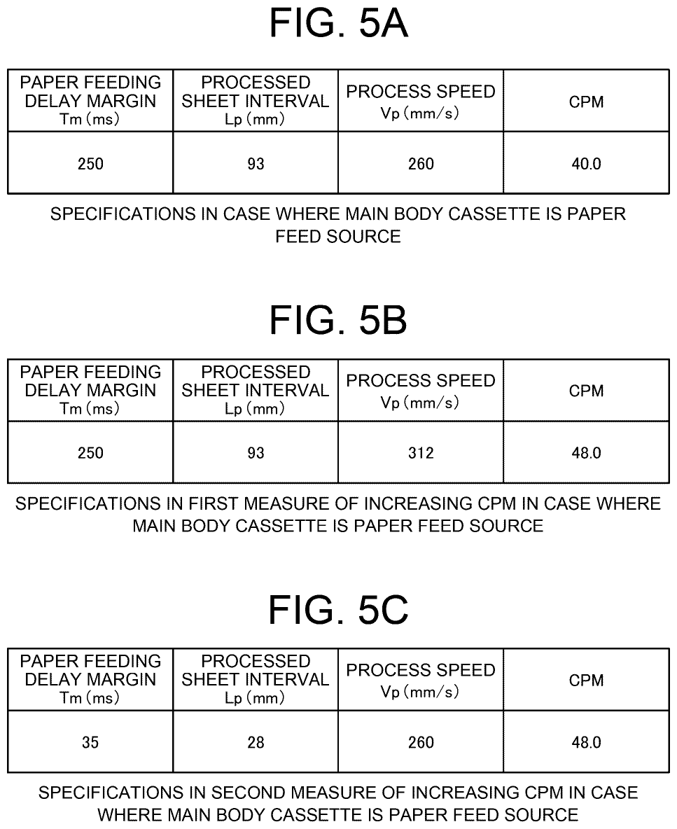

More specifically, as illustrated in FIG. 5A, when the main body cassette 62 is the paper feed source, the paper feed delay margin Tm is set to 250 ms, for example. In addition, the processed sheet interval Lp is set to 93 mm, for example. These are values derived from an experiment. In the case where the process speed Vp is 260 mm/s, the CPM is 40.0. Each of the values illustrated in FIG. 5A is an example in a case where the sheet in an A4 size (297 mm×210 mm) is conveyed in a state where a longitudinal direction thereof is along the conveyance direction. This also applies to each value, which will be described below.

For example, a measure of increasing the value of the CPM by 20% to 48.0 in the image forming apparatus 10 (the image forming apparatus main body 10a) having such specifications. As a first measure, as illustrated in FIG. 5B, a measure of increasing the process speed Vp in a state of maintaining the paper feed delay margin Tm at 250 ms and maintaining the processed sheet interval Lp at 93 mm is considered. According to this first measure, the CPM can be increased to 48.0 by increasing the process speed Vp to 312 mm/s. However, in order to increase the process speed Vp, corresponding cost is required, that is, the cost of the image forming apparatus 10 is increased.

Apart from the above, as a second measure, as illustrated in FIG. 5C, a measure of reducing the paper feed delay margin Tm and the processed sheet interval Lp in a state of maintaining the process speed Vp at 260 mm/s is considered. According to this second measure, the CPM can be increased to 48.0 by setting the paper feed delay margin Tm to 35 ms and setting the processed sheet interval Lp to 28 mm. However, when the paper feed delay margin Tm is reduced, the conveyance error is likely to occur. In addition, and when an attempt is made to reduce this conveyance error, the cost of the image forming apparatus 10 is increased.

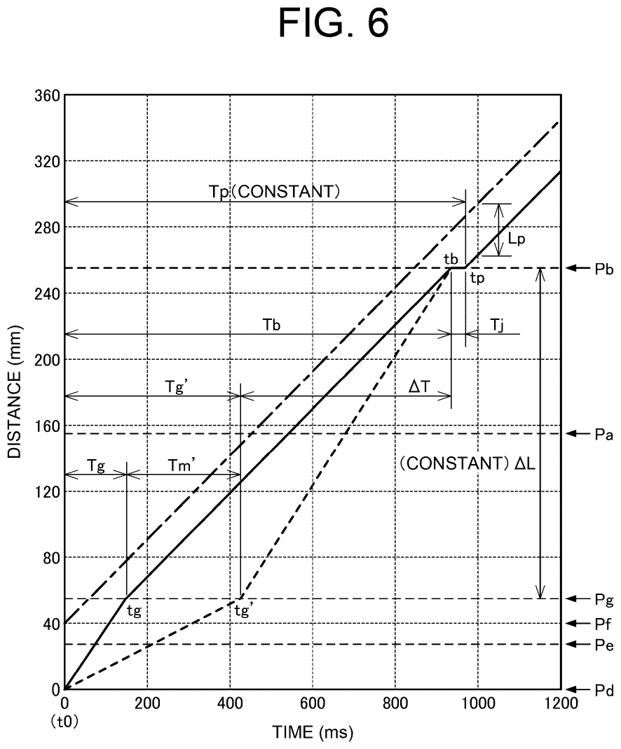

In view of the above, in this first embodiment, the CPM is improved by focusing on the following fact. In the case where the optional paper feeder 100 (the optional cassette 102) is used as the paper feed source, the sheet conveyance distance (conveyance path) from the paper feed source (more strictly, from the nip section Pd of the paper feed roller 106) to the nip section Pb of the resist roller 72a is significantly greater (longer) than the sheet conveyance distance from the paper feed source (more strictly, from the nip section Pa of the paper feed roller 64) to the nip section Pb of the resist roller 72a at the time when the main body cassette 62 is used as the paper feed source. That is, a conveyance speed of the sheet is controlled in a manner to recover the paper feed delay in a process of conveying the sheet from the optional paper feeder 100 as the paper feed source to the nip section Pb of the resist roller 72a. This will be described with reference to FIG. 6.

FIG. 6 is a diagram illustrating the relationship between the conveyance time and the conveyance distance of the sheet of a case where the optional paper feeder 100 is set as the paper feed source. In this FIG. 6, the time point to, at which the rotation of the paper feed roller 106 in the optional paper feeder 100 is started, is set as the base point of the conveyance time. The nip section Pd of the paper feed roller 106 in the optional paper feeder 100 is set as the base point of the conveyance distance. A bold solid line in this FIG. 6 indicates the transition of the leading edge of the sheet in a case where the sheet is conveyed ideally. A bold broken line in FIG. 6 indicates an example of the transition of the leading edge of the sheet in the case where the paper feed delay occurs. Furthermore, a bold one-dot chain line in FIG. 6 indicates the transition of the rear edge of the preceding sheet in the case where printing is continuously performed on the plural sheets of paper.

As illustrated in FIG. 6, in particular, as indicated by the bold solid line, when the sheet is conveyed ideally, the leading edge of the sheet reaches the detection position Pg by the delay detection sensor 124, that is, is detected by the delay detection sensor 124 at a time point tg at which a predetermined time Tg elapses from the base point to. During this time, the sheet is conveyed at a higher speed Vg (>Vp) than the process speed Vp (turbo paper feeding), that is, the option-side paper feed motor 114 and the acceleration/deceleration motor 116 are controlled such that the sheet is conveyed at the speed Vg. This speed Vg is set to such a value at which the leading edge of the sheet does not catch up with the rear edge of the preceding sheet. Then, after passing the time point tg, the sheet conveyance speed is set to the same speed as the process speed Vp, and then the sheet is continuously conveyed. Thereafter, at the time point tb at which the predetermined time Tb elapses from the base point to, the leading edge of the sheet reaches the nip section Pb of the resist roller 72a.

Meanwhile, when the paper feed delay occurs, as indicated by the bold broken line in FIG. 6, the leading edge of the sheet reaches the detection position Pg by the delay detection sensor 124 at a time point tg′, which is later than the time point tg. Here, a conveyance speed Vx for causing the leading edge of the sheet to reach the nip section Pb of the resist roller 72a the time point tb, that is, for causing the leading edge of the sheet to reach the nip section Pb of the resist roller 72a at ideal timing is calculated. The conveyance speed Vx is calculated by following Equation 1. Here, ΔT in Equation 1 is a time from the time point tg′ to the time point tb, that is, a difference between the time Tg′ from the base point t0 to the time point tg′ of the conveyance time and the time Tb from the base point t0 to the time point tb (ΔT=Tb−Tg′). In addition, ΔL is a distance from the detection position Pg by the delay detection sensor 124 to the nip section Pb of the resist roller 72a, and is constant.

$$Vx = Δ L / Δ T \qquad Equation 1$$

Then, after passing the time point tg′, the sheet is conveyed (accelerated) at the conveyance speed Vx calculated by this Equation 1, that is, the option-side paper feed motor 114 and the acceleration/deceleration motor 116 are controlled such that the sheet is conveyed (accelerated) at the conveyance speed Vx. As a result, basically (substantially) at the time point tb, the leading edge of the sheet reaches the nip section Pb of the resist roller 72a, and the paper feed delay is recovered.

An appropriate allowable range, that is, a paper feed delay margin Tm′ is also provided for the time point at which the leading edge of the sheet reaches the detection position Pg by the delay detection sensor 124. The paper feed delay margin Tm′ is set to a value that can sufficiently recover the paper feed delay by the conveyance (the acceleration) of the sheet the conveyance speed Vx, and is thus set to 250 ms, for example. However, the value of the paper feed delay margin Tm′ depends on a maximum value of the conveyance speed Vx. In the case where the leading edge of the sheet does not reach the detection position Pg by the delay detection sensor 124 before this paper feed delay margin Tm′ elapses, that is, by the time point tg′, the conveyance error occurs.

In the case where such a conveyance error does not occur, the leading edge of the sheet basically reaches the nip section Pb of the resist roller 72a at the time point tb as described above. However, the timing at which the leading edge of the sheet reaches the nip section Pb of the resist roller 72a is slightly advanced or delayed. This variation in the timing is caused by a response delay at the time of switching (the acceleration) to the conveyance speed Vx, which is based on Equation 1 described above, a variation in a diameter of the acceleration/deceleration roller 108, or the like, but is extremely small. Accordingly, an appropriate margin, that is, an adjustment margin Tj is provided for the time point at which the leading edge of the sheet reaches the nip section Pb of the resist roller 72a. Here, the adjustment margin Tj is considerably shorter than the above-described paper feed delay margin Tm′ and is set to about 20 ms, for example. That is, until the adjustment margin Tj elapses, the resist roller 72a is not rotated, and the sheet is in the stopped state. Then, at the time point tp at which the adjustment margin Tj elapses, the rotation of the resist roller 72a is started, and the sheet is conveyed to the transfer nip section Nt. Also in this case, the resist roller 72a conveys the sheet at the speed corresponding to the process speed Vp. Here, the time Tp from the base point t0 to the time point tp of the conveyance time is constant. The conveyance error also occurs in the case where the leading edge of the sheet does not reach the nip section Pb of the resist roller 72a before the lapse of this time Tp, that is, by the time point tp.

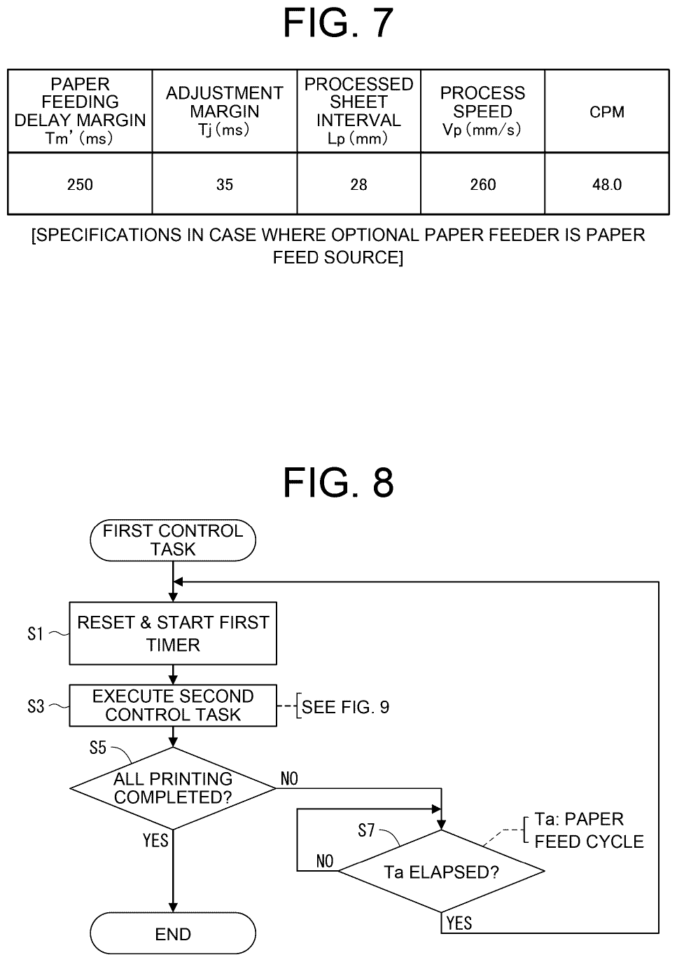

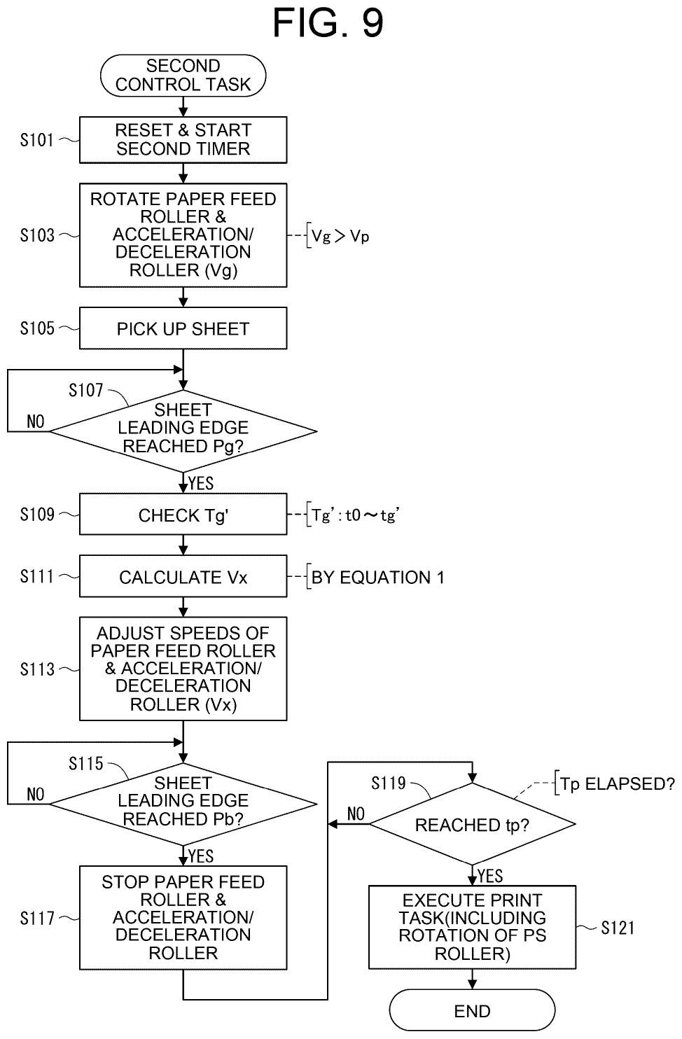

As described above, when the optional paper feeder 100 is set as the paper feed source, the paper feed delay margin Tm′ is set to 250 ms, and the adjustment margin Tj, which is the margin in the nip section of the resist roller 72a, is set to 20 ms. As a result, as illustrated in FIG. 7, the processed sheet interval Lp can be set to 28 mm. Thus, when the process speed Vp is 260 mm/s, the CPM is 48.0, which is increased by 20% in comparison with the case where the main body cassette 62 is used as the paper feed source. In short, the specifications of the image forming apparatus main body 10a are not changed, and the CPM is improved by using the optional paper feeder 100 as the paper feed source.

In order to improve the CPM in the manner as described above, the controller 200, more strictly, the CPU 200a executes a first control task according to a first control program that is included in the control program stored in the primary storage 200b, and executes a second control task according to a second control program included in the control program. These tasks are executed in parallel (multitask processing).

First, the first control task will be described. FIG. 8 illustrates a flow of this first control task. The first control task is executed in response to reception of a print job using the optional paper feeder 100 as the paper feed source. The print job described herein includes not only the print job by the printer function but also the print jobs by the copy function and the facsimile function (a facsimile reception function).

According to this first control task, in first step S1, the CPU 200a resets a timer (not illustrated) for measuring time and then starts the first timer. This first timer is a software timer that is configured by the CPU 200a, for example. However, the first timer may be a hardware timer that is configured by a hardware element such as a real-time clock (RTC). After the CPU 200a executes the processing in this step S1, the processing proceeds to step S3.

In step S3, the CPU 200a executes the second control task, more strictly, starts executing the second control task. This second control task will be described in detail below. Then, the processing proceeds to step S5.

In step S5, the CPU 200a determines whether all the printing that is based on the above-described print job has been completed. Here, if all the printing has been completed (S5: YES), the CPU 200a terminates the first control task. On the other hand, if all the printing has not been completed (S5: NO), the processing proceeds to step S7.

In step S7, the CPU 200a waits until a current measured time that is measured by the above-described first timer reaches a predetermined paper feed cycle Ta, in other words, waits until the paper feed cycle Ta elapses (S7: NO). The paper feed cycle Ta described herein is a value obtained by dividing a unit time of one minute (60 s) by the CPM, that is, the paper feed cycle Ta at the time when the CPM is 48.0 is 1.25 s (=60 s/48.0). When the paper feed cycle Ta elapses (S7: YES), the processing returns to step S1.

Next, the second control task will be described. As described above, the execution of the second control task is started in step S3 of the first control task.

According to this second control task, in first step S101, the CPU 200a resets a second timer (not illustrated) for measuring time and then starts the second timer. Similar to the first timer described above, this second timer is the software timer, for example. However, the second timer may be the hardware timer. Then, the processing proceeds to step S103.

In step S103, the CPU 200a starts the rotation of the paper feed roller 106 and the acceleration/deceleration roller 108, that is, controls the option-side paper feed motor 114 and the acceleration/deceleration motor 116 to start the rotation of the paper feed roller 106 and the acceleration/deceleration roller 108. At this time, the CPU 200a controls the option-side paper feed motor 114 and the acceleration/deceleration motor 116 to convey the sheet at the above-described speed Vg (>Vp). Then, the processing proceeds to step S105.

In step S105, the CPU 200a controls the pickup roller 104, more strictly, the above-described vertical movement mechanism to pick up one sheet from the optional cassette 102. As a result, one sheet is picked up from the optional cassette 102, and the picked-up sheet is fed to the optional conveyance path 112 and conveyed at the speed Vg. Then, the processing proceeds to step S107.

In step S107, the CPU 200a waits until the leading edge of the sheet reaches the detection position Pg by the delay detection sensor 124, that is, waits until the leading edge of the sheet is detected by the delay detection sensor 124 (S107: NO). Then, when the leading edge of the sheet reaches the detection position Pg by the delay detection sensor 124 (S107: YES), the processing proceeds to step S109.

In step S109, the CPU 200a checks the current measured time by the above-described second timer, that is, checks the time Tg′ from the base point to of the conveyance time to the time point tg′ at which the leading edge of the sheet reaches the detection position Pg by the delay detection sensor 124. Then, the processing proceeds to step S111.

In step S111, the CPU 200a calculates the conveyance speed Vx for causing the leading edge of the sheet to reach the nip section Pb of the resist roller 72a at the time point tb, which is the ideal timing, on the basis of Equation 1. Then, the processing proceeds to step S113.

In step S113, the CPU 200a adjusts (accelerates) the conveyance speed of the paper feed roller 106 and the acceleration/deceleration roller 108, that is, controls the option-side paper feed motor 114 and the acceleration/deceleration motor 116 such that the sheet is conveyed at the conveyance speed Vx based on Equation 1. Then, the processing proceeds to step S115.

In step S115, the CPU 200a waits until the leading edge of the sheet reaches the nip section Pb of the resist roller 72a (S115: NO). Then, when the leading edge of the sheet reaches the nip section Pb of the resist roller 72a (S115: YES), the processing proceeds to step S117.

In step S117, the CPU 200a stops the rotation of the paper feed roller 106 and the acceleration/deceleration roller 108, that is, controls the option-side paper feed motor 114 and the acceleration/deceleration motor 116 to stop the rotation of the paper feed roller 106 and the acceleration/deceleration roller 108. Then, the processing proceeds to step S119.

In step S119, the CPU 200a waits until the time point tp, which is the timing to rotate the resist roller 72a, in other words, waits until the time measured by the above-described first timer reaches the time Tp (S119: NO). Then, when the time point tp comes (S119: YES), the processing proceeds to step S121.

In step S121, the CPU 200a executes a print task for printing by the image former 26, including rotating the resist roller 72a, more strictly, starts executing the print task. This print task is a different task from the first control task and the second control task, and is executed in parallel with the first control task and the second control task. As a result, the image former 26 performs printing. With this, the CPU 200a terminates the second control task. A detailed description on the print task will not be made.

As described above, according to the first embodiment, the CPM is improved by setting the optional paper feeder 100 as the paper feed source. That is, although the specifications of the image forming apparatus main body 10a are not changed, the CPM of the image forming apparatus 10 as a whole is improved, that is, productivity thereof is improved. In particular, the user who is conscious of the productivity tends to perform a large volume of printing and, for this purpose, tends to purchase the optional paper feeder 100. For such a user, the first embodiment is extremely beneficial. On the other hand, the user who does not have to place importance on the productivity but is cost-conscious only needs to purchase the image forming apparatus main body 10a. In particular, the image forming apparatus main body 10a is a so-called low-cost machine with the small number of the conveyance rollers 72, and the like. Such an image forming apparatus main body 10a is extremely convenient for the user who is cost-conscious. That is, it is possible to provide various variations to the market.

The optional cassette 102 in the first embodiment is an example of the first accommodation device according to the present disclosure. The optional conveyance path 112 and the paper feed roller 106 in the first embodiment are examples of the first conveyance path and the first paper feed roller according to the present disclosure, respectively. The option-side paper feed motor 114, which is the drive source of the paper feed roller 106, is a so-called first paper feed drive source. Furthermore, the delay detection sensor 124 in the first embodiment is an example of the first detector according to the present disclosure. This delay detection sensor 124 is provided in the optional paper feeder 100, but may be provided in the image forming apparatus main body 10a. Moreover, the paper feeding detection sensor 122 in the first embodiment is an example of the second detector according to the present disclosure.

The main body cassette 62 in the first embodiment is an example of the second accommodation device according to the present disclosure. The main body side conveyance path 66 and the paper feed roller 64 in the first embodiment are examples of the second conveyance path and the second paper feed roller according to the present disclosure, respectively. In addition, the main body side paper feed motor 65, which is the drive source of the paper feed roller 64, is a so-called second paper feed drive source. Furthermore, the processed sheet interval Lp in the case where the optional paper feeder 100 is the paper feed source is an example of the first sheet interval according to the present disclosure. Moreover, the processed sheet interval Lp in the case where the main body cassette 62 is the paper feed source is an example of the second sheet interval according to the present disclosure.

### Second Embodiment

Next, a second embodiment of the present disclosure will be described.

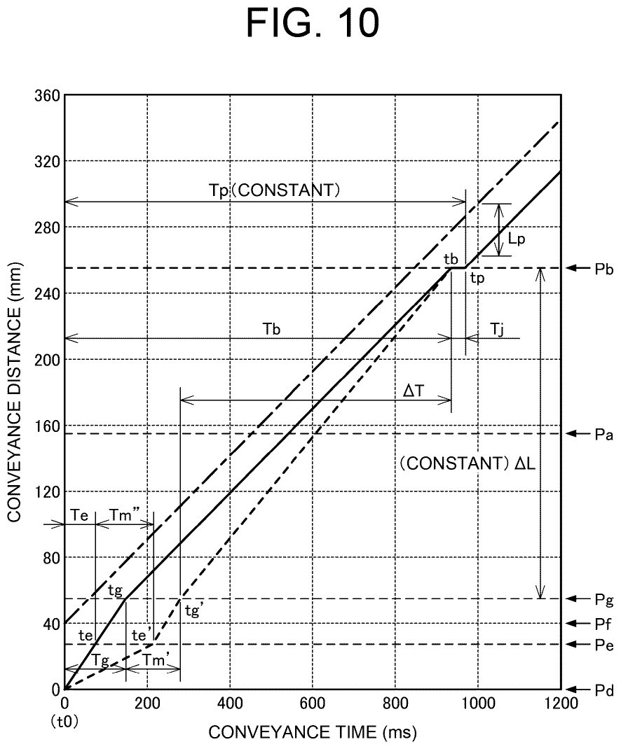

In the second embodiment, the detection result by the paper feeding detection sensor 122 is also used for the conveyance control of the sheet in the case where the optional paper feeder 100 is set as the paper feed source. FIG. 10 is a diagram illustrating the relationship between the conveyance time and the conveyance distance of the sheet in the second embodiment. A bold solid line in FIG. 10 indicates the transition of the leading edge of the sheet in the case where the sheet is conveyed ideally. A bold broken line in FIG. 10 indicates an example of the transition of the leading edge of the sheet in the case where the paper feed delay occurs. Furthermore, a bold one-dot chain line in FIG. 10 indicates the transition of the rear edge of the preceding sheet in the case where printing is continuously performed on the plural sheets of paper.

As illustrated in FIG. 10, in particular, as indicated by the bold solid line, when the sheet is conveyed ideally, the leading edge of the sheet moves in the same manner as in the first embodiment described above (FIG. 6). However, the leading edge of the sheet reaches the detection position Pe by the paper feeding detection sensor 122, that is, is detected by the paper feeding detection sensor 122 at a time point te at which a predetermined time Te elapses from the base point t0. Then, at the time point tg, at which the longer predetermined time Tg elapses from the base point t0, the leading edge of the sheet reaches the detection position Pg by the delay detection sensor 124, that is, is detected by the delay detection sensor 124. During this time, the sheet is conveyed at the above-described speed Vg that is higher than the process speed Vp. Then, after passing the time point tg, the conveyance speed of the sheet is set to the same speed as the process speed Vp, and the sheet is continuously conveyed. Thereafter, at the time point tb at which the predetermined time Tb elapses from the base point to, the leading edge of the sheet reaches the nip section Pb of the resist roller 72a.

On the contrary, when the paper feed delay occurs, as indicated by a bold broken line in FIG. 10, the leading edge of the sheet reaches the detection position Pe by the paper feeding detection sensor 122 at the time point te′ that is later than the time point te. Here, the transport speed of the sheet is increased, for example, increased to the maximum value thereof, and so-called rough control is executed. As a result, the paper feed delay is recovered to some extent.

Here, an appropriate allowable range is also provided for the time point at which the leading edge of the sheet reaches the detection position Pe′ by the paper feeding detection sensor 122, and a so-called first paper feed delay margin Tm″ is provided. This first paper feed delay margin Tm″ is set to be shorter than the paper feed delay margin Tm in the case where the main body cassette 62 is set as the paper feed source, for example, and is set to 200 ms in detail. In the case where the leading edge of the sheet does not reach the detection position Pg by the paper feeding detection sensor 122 before a lapse of this paper feed delay margin Tm″, that is, by the time point te′, the conveyance error occurs.

When such a conveyance error does not occur, the leading edge of the sheet reaches the detection position Pg by the delay detection sensor 124 at the time point tg′ that is later than the time point te′. Here, the conveyance speed Vx for causing the leading edge of the sheet to reach the nip section Pb of the resist roller 72a the time point tb, that is, for causing the leading edge of the sheet to reach the nip section Pb of the resist roller 72a at the ideal timing is calculated. This conveyance speed Vx is also calculated by above-described Equation 1. Then, the sheet is conveyed at the calculated conveyance speed Vx, and so-called detailed control is executed. As a result, basically (substantially) at the time point tb, the leading edge of the sheet reaches the nip section Pb of the resist roller 72a, that is, the paper feed delay is recovered. The processing hereafter is the same as the processing in the first embodiment.

An appropriate allowable range is also provided for the time point at which the leading edge of the sheet reaches the detection position Pg of the delay detection sensor 124, that is, a second paper feeding delay margin Tm′ is provided. This second paper feed delay margin Tm′ is set to 250 ms, for example, that is equivalent to the paper feed delay margin Tm in the case where the main body cassette 62 is the paper feed source. Also, in the case where the leading edge of the sheet does not reach the detection position Pg by the delay detection sensor 124 before this second paper feed delay margin Tm′ elapses, that is, by the time point tg′, the conveyance error occurs.

As described above, according to the second embodiment, the conveyance control of the sheet is executed in two stages of the rough control and the detailed control. That is, in the case where the paper feed delay occurs at the time point at which the leading edge of the sheet reaches the detection position Pe by the paper feeding detection sensor 122, that is, before the leading edge of the sheet reaches the detection position Pg by the delay detection sensor 124, the so-called conveyance control in the first stage is executed to recover this paper feed delay to some extent. Then, in the case where the paper feed delay still occurs at the time point at which the leading edge of the sheet reaches the detection position Pg by the delay detection sensor 124, the conveyance control in the second stage is executed to recover this paper feed delay precisely. As a result, the allowable range for the paper feed delay is substantially expanded, that is, the longer paper feed delay can be handled. Then, similar to the first embodiment, the CPM can be improved by using the optional paper feeder 100 as the paper feed source.

### Third Embodiment

Next, a third embodiment of the present disclosure will be described.

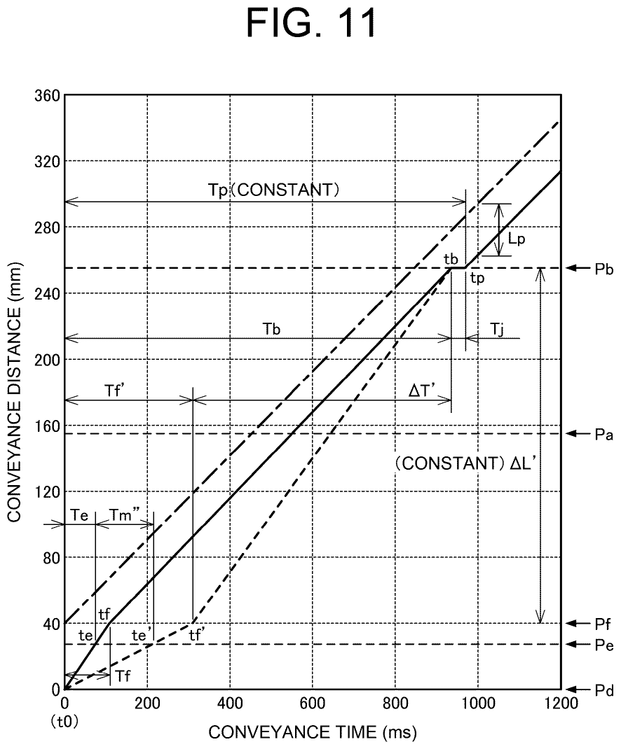

In this third embodiment, the delay detection sensor 124 is eliminated from the configuration of the image forming apparatus 10. That is, in the first embodiment and the second embodiment described above, the detection result by the delay detection sensor 124 is used for the conveyance control of the sheet when the optional paper feeder 100 is set as the paper feed source. However, in the third embodiment, the detection result by the delay detection sensor 124 is not used for the conveyance control of the sheet when the optional paper feeder 100 is set as the paper feed source. FIG. 11 is a diagram illustrating the relationship between the conveyance time and the conveyance distance of the sheet in the third embodiment. A bold solid line in FIG. 11 indicates the transition of the leading edge of the sheet in the case where the sheet is conveyed ideally. A bold broken line in FIG. 11 indicates an example of the transition of the leading edge of the sheet in the case where the paper feed delay occurs. Furthermore, a bold one-dot chain line in FIG. 11 indicates the transition of the rear edge of the preceding sheet in the case where printing is continuously performed on the plural sheets of paper.

As illustrated in FIG. 11, in particular, as indicated by the bold solid line, when the sheet is conveyed ideally, the leading edge of the sheet reaches the detection position Pe by the paper feeding detection sensor 122, that is, is detected by the paper feeding detection sensor 122 at the time point te at which the predetermined time Te elapses from the base point to. Thereafter, at a time point tf at which a long predetermined time Tf elapses from the base point to, the leading edge of the sheet reaches the nip section of the acceleration/deceleration roller 108. During this time, the sheet is conveyed at the above-described speed Vg that is higher than the process speed Vp. Then, at the time point te, the time point tf at which the leading edge of the paper reaches the nip section of the acceleration/deceleration roller 108 is predicted, and the paper feed roller 106 and the acceleration/deceleration roller 108 are rotated, that is, the option-side paper feed motor 114 and the acceleration/deceleration motor 116 are controlled such that the conveyance speed of the sheet becomes the same speed as the process speed Vp at this predicted time point tf. As a result, the leading edge of the sheet reaches the nip section Pb of the resist roller 72a at the time point tb at which the predetermined time Tb elapses from the base point to.

On the contrary, when the paper feed delay occurs, as indicated by the bold broken line in FIG. 11, the leading edge of the sheet reaches the detection position Pe by the paper feeding detection sensor 122 at the time point te′ that is later than the time point te. At this time point te′, the time point tf, at which the leading edge of the sheet reaches the nip section of the acceleration/deceleration roller 108, is predicted. In addition, at the time point te′, a conveyance speed Vx′ for causing the leading edge of the sheet to reach the nip section Pb of the resist roller 72a in a time ΔT′ from the time point tf to the time point tb, that is, for causing the leading edge of the sheet to reach the nip section Pb of the resist roller 72a at ideal timing is calculated. This conveyance speed Vx′ is calculated by following Equation 2. Here, AT′ in Equation 2 is the time from the time point tf to the time point tb as described above, that is, a difference between a time Tf from the base point t0 to the time point tf of the conveyance time and the time Tb from the base point t0 to the time point tb (ΔT′=Tb-Tf). In addition, ΔL′ is a distance from the nip section Pf of the acceleration/deceleration roller 108 to the nip section Pb of the resist roller 72a, and is constant.

$${V}^{′} = Δ {L}^{′} / Δ {T}^{′} \qquad Equation 2$$

Then, at the time point tf, the sheet is conveyed at the conveyance speed Vx′ calculated by this Equation 2, that is, the sheet is accelerated. As a result, basically (substantially) at the time point tb, the leading edge of the sheet reaches the nip section Pb of the resist roller 72a, and the paper feed delay is recovered. The processing hereafter is the same as the processing in the first embodiment.

Here, the appropriate allowable range, that is, the paper feed delay margin Tm″ is provided for the time point at which the leading edge of the sheet reaches the detection position Pe by the paper feeding detection sensor 122. This paper feed delay margin Tm″ is set to be shorter than the paper feed delay margin Tm in the case where the main body cassette 62 is set as the paper feed source, for example. In detail, similar to the first paper feed delay margin Tm″ in the second embodiment described above, the paper feed delay margin Tm″ is set to 200 ms. In the case where the leading edge of the sheet does not reach the detection position Pe by the paper feeding detection sensor 122 before the lapse of this paper feed delay margin Tm″, that is, by the time point te′, the conveyance error occurs.

As described above, according to the third embodiment, even in the configuration in which the delay detection sensor 124 is eliminated, similar to the first embodiment and the second embodiment described above, the CPM is improved by setting the optional paper feeder 100 as the paper feed source. In addition, since the delay detection sensor 124 is eliminated, the configuration of the entire image forming apparatus 10 can be further simplified, and the cost can be further reduced.

Furthermore, for example, in the first embodiment described above, the conveyance control (the acceleration) of the sheet is started to recover the paper feed delay at the time point at which the leading edge of the sheet reaches the detection position Pg by the delay detection sensor 124 (when the paper feed delay occurs). Meanwhile, in the third embodiment, the conveyance control of the sheet is started to recover the paper feed delay at the time point at which the leading edge of the sheet reaches the nip section Pf of the acceleration/deceleration roller 108, which is located on the upstream side of the detection position Pg by the delay detection sensor 124 in the paper conveyance direction (when the paper feed delay occurs). Therefore, the allowable range for the paper feed delay is expanded when compared to that in the first embodiment, that is, the long paper feed delay can be handled.

### Other Application Examples

Each of the embodiments described so far is a specific example of the present disclosure and does not limit the technical scope of the present disclosure. The present disclosure may be applied to aspects other than the embodiments.

For example, the value of the paper feed delay margin Tm, the processed sheet interval Lp, and the like in each of the embodiments are merely examples, and the present disclosure is not limited to these values.

The paper feed roller 106 and the acceleration/deceleration roller 108 in the optional paper feeder 100 are driven by the mutually different drive sources (the option-side paper feed motor 114 and the acceleration/deceleration motor 116), but may be driven by a common (one) drive source. In this case, it is desirable that a clutch is provided in one or both of the paper feed roller 106 and the acceleration/deceleration roller 108 and that this clutch is optionally turned on/off.

Furthermore, the optional paper feeder 100 is controlled by the controller 200 of the image forming apparatus main body 10a. However, the present disclosure is not limited thereto. For example, a separate controller may be provided for the optional paper feeder 100, and the optional paper feeder 100 may be controlled by this separate controller.

The image forming apparatus 10 in each of the embodiments is the color MFP. However, the present disclosure can also be applied to a monochrome MFP. In addition, the image forming apparatus 10 in each of the embodiments is of the electrophotographic type. However, the present disclosure can also be applied to the image forming apparatus 10 of an ink jet type. Furthermore, the present disclosure can be applied to an image forming apparatus other than a multifunction peripheral, such as a printer-only machine, a copy-only machine, or a facsimile-only machine.

The present disclosure is not limited to the form of the apparatus such as the image forming apparatus, and can be provided in the form of a method such as a method for controlling the optional paper feeder in the image forming apparatus.

While there have been described what are at present considered to be certain embodiments of the invention, it will be understood that various modifications may be made thereto, and it is intended that the appended claim cover all such modifications as fall within the true spirit and scope of the invention.

What is claimed is:

1. An image forming apparatus comprising:
an image forming apparatus main body; and
an optional paper feeder optionally attachable to the image forming apparatus main body,
the image forming apparatus main body having:
an image former that executes image forming processing to form an image on a sheet-like image recording medium; and
a resist roller that conveys the image recording medium to an image forming processing position by the image former, and
the optional paper feeder having:
a first accommodation device that accommodates a plurality of the image recording media;
a first paper feed roller that feeds the image recording media one by one from the first accommodation device to a first conveyance path connected to a conveyance position of the image recording medium by the resist roller; and
an acceleration/deceleration roller that conveys the image recording medium fed to the first conveyance path to the conveyance position by the resist roller, the image forming apparatus further comprising:
a controller that is provided in the image forming apparatus main body or the optional paper feeder and controls a conveyance speed of the image recording medium by the acceleration/deceleration roller such that a leading edge of the image recording medium conveyed by the acceleration/deceleration roller reaches the conveyance position by the resist roller at a predetermined time point at which a predetermined time elapses from a feeding start time point of the image recording medium to the first conveyance path by the first paper feed roller.

2. The image forming apparatus according to claim 1 further comprising:
a first detector that is provided at a position between the conveyance position of the image recording medium by the acceleration/deceleration roller and the conveyance position by the resist roller in the first conveyance path and near the conveyance position by the acceleration/deceleration roller and that detects the leading edge of the image recording medium, wherein
the controller controls the conveyance speed by the acceleration/deceleration roller on the basis of a detection result by the first detector.

3. The image forming apparatus according to claim 1 further comprising:
a second detector that is provided between a feeding position of the image recording medium to the first conveyance path by the first paper feed roller and the conveyance position of the image recording medium by the acceleration/deceleration roller in the first conveyance path and that detects the leading edge of the image recording medium, wherein
the controller controls the conveyance speed by the acceleration/deceleration roller on the basis of a detection result by the second detector.

4. The image forming apparatus according to claim 1 further comprising:
a first detector that is provided at a position between the conveyance position of the image recording medium by the acceleration/deceleration roller and the conveyance position by the resist roller in the first conveyance path and near the conveyance position by the acceleration/deceleration roller and that detects the leading edge of the image recording medium; and
a second detector that is provided between a feeding position of the image recording medium to the first conveyance path by the first paper feed roller and the conveyance position by the acceleration/deceleration roller in the first conveyance path and that detects the leading edge of the image recording medium, wherein
the controller controls the conveyance speed by the acceleration/deceleration roller on the basis of a detection result by each of the first detector and the second detector.

5. The image forming apparatus according to claim 1, wherein
the image forming apparatus main body further has:
a second accommodation device that accommodates a plurality of the image recording media; and
a second paper feed roller that feeds the image recording media one by one from the second accommodation device to a second conveyance path connected to the conveyance position by the resist roller, wherein
the image recording medium that is fed to the second conveyance path by the second paper feed roller is conveyed, by the second paper feed roller, to the conveyance position by the resist roller.

6. The image forming apparatus according to claim 5, wherein
an image formation processing speed by the image former is the same in both of a case where the image forming processing is performed on the image recording medium conveyed from the first accommodation device to the conveyance position by the resist roller via the first conveyance path and a case where the image forming processing is performed on the image recording medium conveyed from the second accommodation device to the conveyance position by the resist roller via the second conveyance path.

7. The image forming apparatus according to claim 6, wherein
a first sheet interval that is an interval between a rear edge of the preceding image recording medium and a leading edge of the following image recording medium following the preceding image recording medium at the conveyance position by the resist roller in a case where the plurality of the image recording media is continuously conveyed from the first accommodation device to the conveyance position by the resist roller via the first conveyance path is smaller than a second sheet interval that is an interval between a rear edge of the preceding image recording medium and a leading edge of the following image recording medium following the preceding image recording medium at the conveyance position by the resist roller in a case where the plurality of the image recording media is continuously conveyed from the second accommodation device to the conveyance position by the resist roller via the second conveyance path.

8. A method for controlling an optional paper feeder in an image forming apparatus that includes an image forming apparatus main body and the optional paper feeder optionally attachable to the image forming apparatus main body,
the image forming apparatus main body having:
an image former that executes image forming processing to form an image on a sheet-like image recording medium; and
a resist roller that conveys the image recording medium to an image forming processing position by the image former, and
the optional paper feeder having:
a first accommodation device that accommodates a plurality of the image recording media;
a first paper feed roller that feeds the image recording media one by one from the first accommodation device to a first conveyance path connected to a conveyance position of the image recording medium by the resist roller; and
an acceleration/deceleration roller that conveys the image recording medium fed to the first conveyance path to the conveyance position by the resist roller, the method comprising:
controlling a conveyance speed of the image recording medium by the acceleration/deceleration roller such that a leading edge of the image recording medium conveyed by the acceleration/deceleration roller reaches the conveyance position by the resist roller at a predetermined time point at which a predetermined time elapses from a feeding start time point of the image recording medium to the first conveyance path by the first paper feed roller.
